(19) United States
(12) Patent Application Publication
(10) Pub. No.: US 2002/0034179 A1
(43) Pub. Date: Mar. 21, 2002

(54) IP tunneling service without a return connection

(76) Inventors: Ville Ollikainen, Helsinki (FI); Caj Sodergard, Espoo (FI)

Correspondence Address: SALTAMAR INNOVATIONS, 30 FERN LANE, SOUTH PORTLAND, ME, 04106, US

(21) Appl. No.: 09/929,587

(22) Filed: Aug. 14, 2001

Related U.S. Application Data
(63) Continuation-in-part of application No. PCT/FI00/00111, filed on Feb. 15, 2000.

(30) Foreign Application Priority Data
Feb. 15, 1999 (FI) 990309

(51) Int. Cl. H04L 12/56; H04N 7/16; H04L 12/28

(52) U.S. Cl. 370/389; 725/25; 725/135

(57) ABSTRACT

The problem with transferring an IP packets to another network environment without a return connection, is addressed, by transforming the IP data packets into an alternative addressing form such as Conditional Access (CA). Another aspect of the invention allows for extending an IP network by tunneling or forwarding of IP packets, and preferably multicast service packets within a CA transport mechanism. The disclosure further discloses a method and apparatus for utilizing the method as means of providing IP multicast service data via unidirectional television broadcast system.

This application is a continuation in parts of PCT application number PCT/FI00/0011, filed Feb. 15, 2000, which claims priority to Finnish patent application No. 990309, filed Feb. 15, 1999.

### FIELD OF THE INVENTION

The invention relates to transmitting an IP multicast service, via the Internet, to a receiver without a return connection.

### BACKGROUND

Even today, it is possible to implement a so-called Internet-via-TV device; examples of this are WebTV or NetStation. The device is connected to an ordinary analogue TV set and it allows surfing on the Internet Web pages and sending e-mail. The device simply utilises the TV set's cathode ray tube CRT to display the Web pages received via a modem connection.

Digital television broadcasting offers many advantages compared with the conventional analogue broadcasting method. The picture and sound quality are considerably better, and the same multiplexed transmission allows the broadcasting of pictures to both HDTV (High Definition Television) and SDTV (Standard Definition Television) standards. In addition, the multiplexed transmission makes it possible to transmit multimedia services such as audio, video, data and text.

At present, two digital standards have been established: the American ATSC (Advanced Television System Committee) and the European DVB (Digital Video Broadcasting). The European DVB standard is intended as the basis for satellite transmission, cable transmission, terrestrial transmission and multi-point broadcasting. Video coding and compression are based on the MPEG-2 algorithm, and OFDM (Orthogonal Frequency Division Multiplexing) is used in the terrestrial transmission system. It should be noted however that both ATSC and DVB offer similar capabilities, and while the examples provided herein talk mainly on DVB, adapting the technology to ATSC and similar standards is a matter clear to the person with iordinary skill in the trade.

At its simplest, the digital television is only suitable for receiving a broadcast over the air. As an additional feature, it may also include reception of text transmissions. For receiving pay-TV broadcasts, a card reader and other technical accessories are required. A modem can also be integrated, allowing the set to communicate with an external system either via a wired network or a wireless network. Because, unlike in analogue systems, there is no relation between the service and the channel (frequency) in a digital system, a navigating program is placed in the set, allowing the viewer to receive the desired service. Such a program is called an EPG (Electronic Programme Guide). The more numerous the functions of the TV set, the more memory, processing capacity and utility software it requires.

A digital system makes new types of TV services and new ways of using the TV set possible. The use of a modem makes possible the interactive TV, where the set is capable of running small software applications transmitted as part of the TV broadcasting signal. The viewer can, using the remote control, click on an application that is embedded in the received broadcast and shown on the screen. The application may be, e.g. a small program, embedded in an advertisement, which responds to clicking by performing a certain function shown on the screen. As a response to clicking, the modem may also connect to a remote server, for instance allowing the viewer to order a product right away or to send messages via the modem to the service provider. The TV broadcast being a one-way transmission, the modem connection acts as the missing “return connection”.

The thinking in the industry has been that, commercially speaking, the biggest advantage of the digital TV is its ability to offer the viewer a chance to react immediately to a commercial or paid service, by offering a direct link through a modem to the advertiser's home page or a chance to request, via the modem connection, the service provider to add more information to the general broadcast.

In a digital TV system, it would be advantageous for the service provider to include a data channel in the multiplexed transmission for transmitting data to a specified group of receivers in such a way that the receiver could easily choose which channels he wishes to receive from the multitude of channels on offer. By data channel, we mean other than the audio and video channels of ordinary free or paid television programs. The data channel would be used to transmit, for example, picture files, sound files, text files, software, Web pages, etc.

It would be very advantageous to be able to transmit multicast services produced for the Internet to the TV sets through a multiplexed digital TV transmission. The relevant point about the multicast standard, intended for fixed IP networks, is that the network routers poll the receivers around them at regular intervals, as to which of them wish to receive multicast packets. The receivers notify the router of their willingness to receive the subject multicast broadcast. The standardised multicast transmission would, therefore, in principle be most suitable for wireless mass distribution through a digital television system, but it is not suitable for an environment of the type described above, because it has no return channel. Even if it is a well-known technique to include a modem in digital television sets and to use a fixed network modem connection as the return channel, the return channel is a one-way channel in the sense that it is activated by the TV set.

The problem in transmitting the desired multicast service to the TV environment, or other environment lacking a return connection, is how will the service provider get information about receivers willing to receive the service and how can the multicast router poll the sets as to whether they still want to receive the service they had previously ordered.

### SUMMARY OF THE INVENTION

The objective of this invention is thus to find the mechanisms for implementing a service using the multicast protocol, well known from the Internet environment context and requiring a return connection, in an environment without a return connection such as a digital television system. The problem is solved, using the methods described in the independent patent claims, in such a way that one of the servers within the scope of influence of the multicast router is nominated as the order server. The order server can be an existing server, which operates as an order server while continuing with its other tasks, or a completely new server installed to operate exclusively as an order server. The receiver sets without return connections wishing to receive multicast services notify this server of the services they want to receive, and also give notice when they no longer wish to receive it. Notifying the server can be done via a modem connection through a wired network, using e.g. a Web form. Equally, the receiver set can send the information through radio waves to another receiver, which forwards it to the order server. Information about the receivers' willingness or unwillingness to receive multicast broadcasts is stored in a table in the order server's memory.

From the point of the polling multicast router, the receiver sets have thus been reduced to order servers, or, more specifically, to a table of data in the order server's memory. When a receiver set wants an authorisation to receive the service of its chosen multicast group, it notifies the order server of this. The next time the router makes a query about receivers willing to receive the service, this request by the receiver set is already recorded with the order server which then replies on behalf of the receiver set. In this case, the multicast router will effect the routing of the service in question so that it is available to the receiver set. Routing continues until the last receiver set has notified the order server of its wish to stop receiving the service. Then, the router no longer receives a reply to its query from the order server, and stops routing the service in question to the receiver sets. The order server can also separately notify the router of the termination of the routing.

When the receiver set is a digital television set, the router will effect the routing of the multicast packets to the broadcasting system of the television operator's broadcasting network, which will then add the packets to the multiplexed transmission of the general broadcast. The receiver set will in turn receive the transmission, recognise the service by its identifier and separate the service packets from the multiplexed transmission.

Thus in one aspect, the invention provides for a TV based multicast system for implementing multicast service over a unidirectional signal distribution system having a transmission system adapted to receive multicast packets and transmit said packets using the distribution system. However the transport of multicast packets also provides for extending IP based networks into a television broadcast domain and similar unidirectional distribution networks.

Thus in an important aspect of the present invention, there is provided a method comprising the step of translating Internet Protocol (IP) addresses contained within IP packets, into Conditional Access (CA) domain.

A valuable method for addressing Internet Protocol (IP) packets having IP format address information, in a Conditional Access (CA) capable television network, is provided. The method comprising the steps of selecting a CA code from a database, using said IP format address or a portion thereof as search criteria; and encoding at least a portion of the data of said packet using said CA code, to produce a CA encoded data. The portion of the IP address is preferably the domain prefix.

The method may further comprise the step of transforming said CA encoded data to a format suitable for digital television transmission. It may further comprise the step of transmitting said CA encoded data via a television distribution network.

The present invention further contemplates the step of translating said IP address or a portion thereof, into a private address. At least a portion of said private address, or a combination of IP address and/or the translated private address, may be embedded in said CA encoded data. Preferably, the address or a portion thereof may be encoded in the CA encoded data.

As discussed elsewhere in this application, it is desirable but not mandatory that the IP packets represent a multicast stream. Also, the system is particularly suited to unidirectional distribution system which comprises a digital television distribution system.

Thus, the invention further teaches a method of integrating of a television based network with an Internet Protocol (IP) network, the method comprising the steps of: receiving packets from an IP network, said packets having IP address information embedded therein; selecting a conditional access (CA) code from a database, using said IP format address or a portion thereof as search criteria; encoding at least a portion of the data of said packet using said CA code, to produce a CA encoded data; and transmitting the CA encoded data via a television distribution network, for reception by a reception device adapted to decode said CA encoded data.

The method may further comprise the step of performing domain address translation on said IP address information, to form a private address. The method may also comprise the step of encoding or embedding at least a portion of said private address or IP address in said CA encoded data. As in other aspects of this invention, at least a portion of said IP packets may represent a multicast stream.

When viewed as an arrangement for adapting packets received from a service in a computer network to further broadcasting in a broadcast network system, said packets being addressed to receivers ordered the service, another aspect of the invention is characterized in that the arrangement comprises a scrambler key database storing a plurality of scrambler keys, each linked to at least one network prefix, means for scrambling the payload of each packet with a scrambler key fetched from the scrambler key database on the basis of the domain address of the packet, wherein the domain address of the packet received from the computer network determines the scrambling key applied to the payload of the packet.

The arrangement may be further characterized in that scrambling is a step of a conditional access system, wherein conditional access subsystems in the receivers are able to descramble packets only when authorized to do so.

The arrangement may be further characterized in that the arrangement further comprises an address database storing a plurality of intra-system addresses, each linked to at least one network prefix, and means for replacing the network prefix of each packet with the intra-system address fetched from the secondary address database on the basis of the domain address of the packet.

In a preferred embodiment, the arrangement is further, characterized in that an intra-system address is common to a group of receivers. In a complementary or independent arrangement, a local part of the address of the packet received from the computer network remains, wherein a receiver is able to route the packet received from the broadcast network further towards equipment provided with said local address.

### BRIEF DESCRIPTION OF THE DRAWINGS

The invention will be described below with the aid of the appended schematic drawings, wherein

FIG. 1 shows a multicast system,

FIG. 2 shows an arrangement according to the invention in an environment without a return connection,

FIG. 3 shows a digital television system with a multicast service, and

FIG. 4 shows the handling of addresses at transmitting and receiving ends.

### DETAILED DESCRIPTION OF THE INVENTION

IP traffic is nearly always point-to-point traffic between the transmitter and the receiver. If the server transmits the same piece of information to several addresses, it must send it as many times as there are recipients. Thus, the same information travels between the transmitting server and the first router N times (N being the number of receivers). If the server routes packets to different links, then the same information naturally travels in the following link less than N times. This method is called unicast transmission. The unicast method of transmitting is poorly suited to mass distribution. To overcome this shortcoming, a method of multicast transmission has been developed, in which the transmitter sends data and receivers interested in that data receive it, while others filter it away.

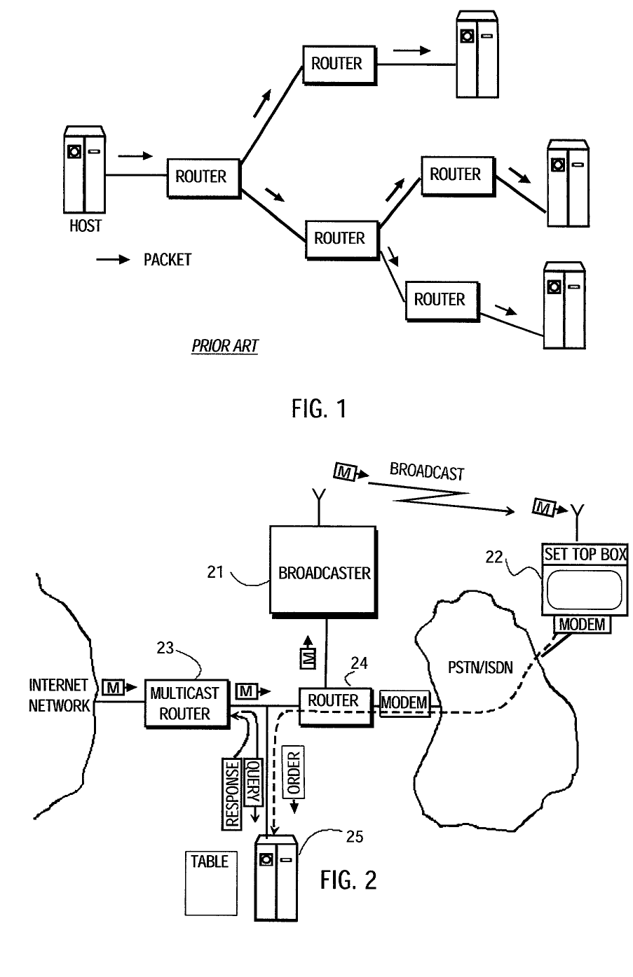

FIG. 1 shows the principle of multicast transmission. Receivers 1, 2 and 3 are all part of the same multicast group to which the host server 4, (Host), transmits data. The Host only transmits the data once, and the following routers only send the data in the necessary directions once. It is worth mentioning that in interactive data transfer, all servers 1 to 4 are host servers. Multicast is an excellent method for, for example, forming and maintaining a video conference between several participants, for transferring the same video to several receivers, etc. The multicast data transfer is facilitated by a protocol called IGMP (Internet Group Management Protocol), further information of which is available in its defining standard RFC 1112. The protocol will be briefly explained below.

A unique class D IP address that differs from all other IP addresses identifies each group using a multicast service. The address space of class D spans from 224.0.0.0 to 239.255.255.255. The receiver address contained in the multicast packet is, therefore, the address of a group, not the address of an individual device as is the case with the unicast method of transmission. Hence, each packet in the same service group has the same address, based on which the members of the group receive the correct packets and filter others away. The members of the group can be located anywhere in the Internet. They can join the group at any time by notifying the multicast router. The UDP protocol, instead of TCP, is used for relaying the packets. The essential difference between the protocols is that TCP is connection-based, the receiver sending an acknowledgement for the packet, and packets containing errors being re-sent. However, with the UDP protocol, the packet is transmitted, but its delivery cannot be verified, since in the absence of a return connection, the receiver will not send any acknowledgements to the transmitter. The members use the IGMP protocol to inform the multicast routers in their immediate neighbourhood of their membership in the group. The multicast routers send queries at irregular intervals, usually about once a minute, to the members (hosts) in their immediate neighbourhood, in order to find out the service groups used in the local area networks connected to the members. The members report in their replies all the groups they belong to. A server can be connected to more than one network; then it will only send the reply to the interface where the query came from. If no replies are received from the members of a specific, earlier routed group, the multicast router will stop routing multicast packets of this group to the members.

The above brief description of the IGMP protocol indicates that its essential feature are the queries which the multicast router makes to neighbouring members as to their willingness to receive certain services. Whenever the router receives even a single positive reply, it will continue routing the service in question. If there are no replies, it will stop relaying packets of the subject service.

Multicast relaying can be used successfully in wireless mass distribution by transmitting multicast packets in, for example, the multiplexed transmission of digital television. Then, the replies of the members are facilitated in a manner that is in accordance with the invention.

FIG. 2 shows schematically the principle of this arrangement. The transmitter 21 of the program is transmitting a digital TV transmission received by the sets 22. The sets select the channels the users want from the multiplexed transmission and display them on the screen. This is in itself a familiar technique.

In accordance with the invention, multicast packets of the service that the user wants can be added to the multiplexed transmission. This is done by way of the Internet service provider's local area network being connected through the multicast router 23 to the Internet. The service provider has for example chosen a number of multicast services from which the receivers can choose the ones they want. How the choice is made will be explained later. Let us assume that we want to receive from the Internet, and later transfer to the multiplexed digital TV transmission, the packets M of the multicast service. These packets and their route have been illustrated in the figure by a small box with the letter M. The table of the multicast router 23 contains information of the multicast services in the Internet that it is expected to receive. This means that packets arriving with the address of the service group M are allowed through. Hence, it will receive the packets M coming from the Internet and route them further to the local area network of the Internet service provider. The packets are also routed to the order server. Router 24, which connects the local area network to the network of the digital TV operator 21, routes the packets M further to network 21. The operator will process the packets as necessary so that they can be transmitted in the multiplexed transmission of the general broadcast.

The set-top box connected to the subscriber's TV set 22 separates the data channel carrying the packets M from the multiplexed transmission. It identifies the packets on the basis of their addresses, and separates and relays them for further processing. The processing can take place in the set-top box, allowing the result to be displayed on the TV screen. Alternatively, the packets can be relayed further to the receiver's local area network (not shown in FIG. 2), or temporarily stored in the memory of the set-top box.

When a receiver wishes to quit membership of the multicast group M, he will for instance click on, for example, the button of the electronic program guide. Then, the modem in the receiver set 22 contacts the order server 25 in the local area network of the Internet service provider. An alternative connection is created through the common analogue telephone network PSTN or through an ISDN network. In the latter case, the modem is an ISDN interface. A modem in the modem bank of the local area network identifies the incoming call, after which the router 24 will route the connection to the order server 25. The receiver sends an order to the order server, notifying of his quitting the membership of the multicast group M. The order server saves this information. The next time the multicast server polls its neighbouring servers, in accordance with the IGMP protocol, about their willingness to receive multicast packets, the order server 25 also receives the query. If even the last of the subscribers to the multicast group has quit its membership, the order server 25 will stop giving replies concerning the group in question. After this, the multicast router 23 will no longer allow packets arriving from the Internet into the local area network which means that they will not be arriving in the program broadcaster's 21 network either.

The description above illustrates the idea behind the invention. First, the order server receives the queries from the multicast router and notifies in its reply message that packets in the multicast group, i.e. which services it wishes to receive. Secondly, the receivers notify, in a message (order) sent to the order server through a modem connection, from which group they want to receive packets, as well as of their desire to quit membership of the group. There can be thousands of sets receiving a digital television broadcast, and the order server has a record of all the memberships or non-memberships of a given multicast group. As long as there is at least one receiver in the multicast group, the order server will respond to the query from the multicast router by replying that packets from the service will be received. Only when there are no receivers who want the service will the multicast router reject the packets of the subject service, and they are removed from the multiplexed transmission of the TV broadcast.

In practice, it is probably preferable that the Internet service provider has chosen a number of multicast groups from which the users can select the ones they want. A list of the services on offer can be transmitted in the multiplexed transmission of the TV broadcast, e.g. in connection with an electronic program guide. Alternatively, the list would only exist at the order server, and the users would connect to this server via their modems to choose the multicast groups they want to belong to.

From the user's point, booking the service could be done with an HMTL or XML form, opened using a user ID and password. In connection with the booking, the order server would prepare a list of the ordered multicast services, in a form the digital TV set can read, and transmit it to the set. The same packet could also include orders from other similar servers or from, for example, the centralised database of the digital broadcasting company. There are no standardised formats for this information at the moment, but at its simplest it could be a text file of the Unix HOSTS file type. The receiver set needs information of the services ordered for it to be able to filter the incoming data.

The invention makes possible the transfer of multicast services, available on the Internet, to e.g. a digital TV environment in a simple and almost completely standardised way.

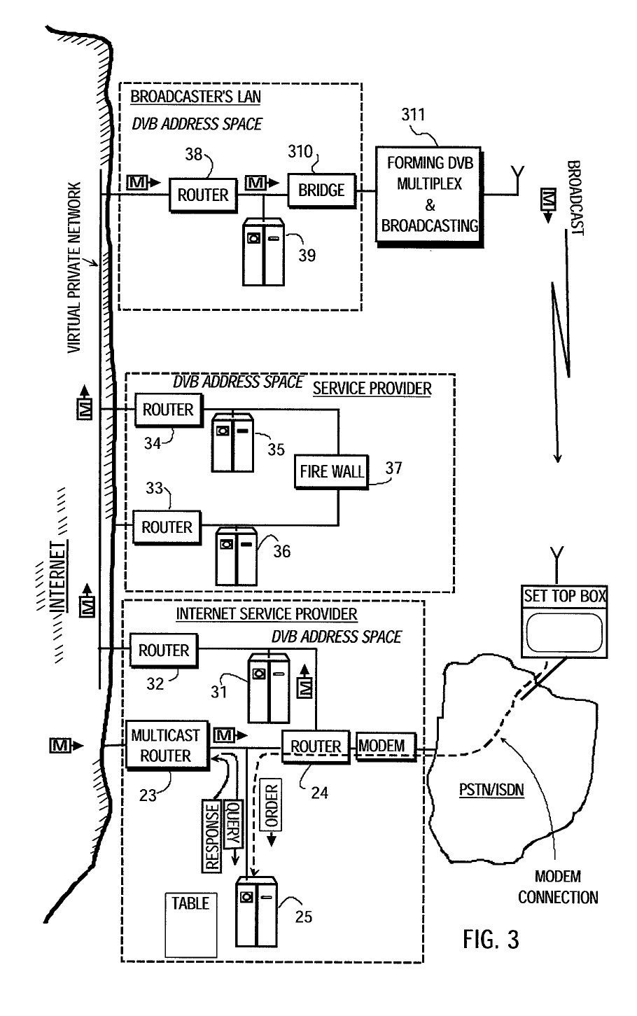

FIG. 3 shows in more detail the application of the invention in a digital TV environment.

It shows three sub-networks which together form a Virtual Private Network (VPN). The sub-networks are connected to each other via the Internet, and are visible to the user as one single network. The creation of VPNs is well known in the field. At the bottom of the figure is the local area network of the Internet service provider 601 with the same elements as illustrated in FIG. 2. The same reference numbers apply. In addition to the order server, the network may include several other servers carrying out other tasks; these are indicated in a general fashion by index number 31. This local area network is connected via a border router to a part of the VPN within the Internet.

The next item is the local area network of the service provider 602. On the one hand, it is connected to the Internet via router 33, and on the other, to the VPN via border router 34. The local area network can include several servers; two of these have been schematically indicated by index numbers 35 and 36. To prevent access from the Internet to certain parts of the local area network, a firewall 37 is used to separate segments of the local area network and to safeguard the data security of the VPN. The service provider or providers—there can be several—produce their own programs that the broadcaster transmits to receivers. The network of the service provider is as such not part of the invention but is shown merely to illustrate the entire system.

At the top, the broadcaster's network 603 is shown. It is connected to the VPN via the border router 38. The broadcaster's LAN is shown with extremely few details, and the one server 39 illustrates all the servers. The network is also connected via the bridge 310 to the forming and broadcasting segment 311 of the multiplexed transmission. This segment symbolises all the functions necessary for processing the program data into a form in which it can be transmitted through radio waves to the receivers.

Since both service providers and Internet service providers deliver the information intended for broadcasting to the broadcaster's network, and all parties are within the same VPN, it is natural that the same address space is visible to all the parties. This address space need not be selected from the general Internet address space; it can be a totally private one. This DVB IP address space can be co-ordinated by e.g. the authorities or the broadcasting company, and addresses for each receiver set are reserved in it.

Receiver sets can have two addresses, one of which is part of the DVB address space. It is an address that is unique and specific to each set, not issued to any other receiver set. The Internet service provider issues the other address.

The Internet service provider receives from the Internet those multicast services of which the users have notified when they registered with the order server 25 through a modem connection via the PSTN. Multicast router 23 rejects packets from other services. The packets are routed in the VPN to the broadcaster's network, as was explained in connection with FIG. 2. Small boxes with the letter M illustrate the route of the packets.

There are several alternatives concerning the addresses of the packets when they are in a multiplexed transmission.

First, addresses defined in the DVB IP address space can be used, because the addresses of the receiver sets are part of the DVB address space. In this case, the DVB address space reaches all the way to the receiving sets. The set checks whether the packet has the same address as that issued to the set by the Internet service provider. If this is the case, the packet is a multicast one and it will be received.

It is also possible to reserve a sufficiently large address space on the Internet for the entire DVB operation. In this case, no address transformations are required, which would simplify the reception of multicast packets. The problem is the capacity of the present Internet address space.

Another alternative is to partly use the same addresses in receiver sets. In this case, an arrangement called Conditional Access (CA) is applied for relaying the IP addresses, an arrangement which is capable of identifying the receiver or receivers. Here, only authorised receivers can descramble the coding and the scrambling done at the transmitting end. Codes for descrambling have been stored in the smart card that the user inserts in the set-top box card reader.

CA is the technology by which service providers enable subscribers to decode and view services. It comprises a combination of scrambling and encryption to prevent unauthorized reception. Encryption is the process of protecting the secret keys that are transmitted with a scrambled signal in the transport stream to enable the descrambler in a receiver to work. The scrambler key, called the control word must, of course, be sent to the receiver in encrypted form as an entitlement control message (ECM). The CA subsystem in the receiver will decrypt the control word only when authorized to do so; that authority is sent to the receiver in the form of an entitlement management message (EMM). This layered approach is fundamental to all proprietary CA systems in use today. The control word is changed at intervals of 10 seconds, typically. The ECM, sometimes called the multi-session key, is changed at perhaps monthly intervals to avoid hackers gaining ground.

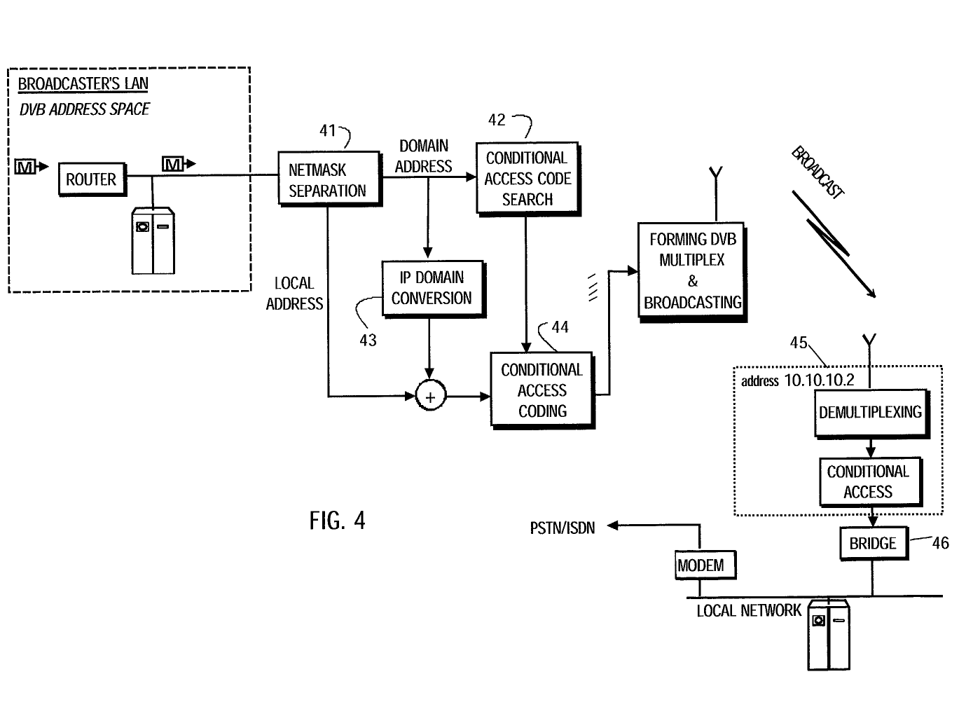

FIG. 4 shows one possible embodiment of the invention in this case. It illustrates functions performed by the bridge 310, prior to the broadcast. The intention is to transform the destination address to be the same as the set's address, and to carry out CA coding.

Let us assume that a packet arriving at the netmask separation segment 41 carries a class C destination address 161.29.152.2. The first three bytes (network prefix) are separated. They identify the receiver set or group of receiver sets that are using Conditional Access. In segment 42, Conditional Access Code Search, the coding and the scrambling method (CA coding information) to be used for this network prefix group is searched from the database. At the same time, the network prefix is relayed to the IP domain conversion segment 43, which transforms the network prefix, e.g. the above mentioned 161.29.152 is transformed for example into 10.10.10, in an operation commonly known as Network Address Translation, or NAT. The transformed network prefix could be shared by all receiver sets that utilise the CA function. The network prefixes could also be TV set specific, allowing the easy integration of DVB receiver sets with existing IP based, or local area networks. After this, the transformed network prefix and the original local address are combined at segment 44, resulting in the transforming of the destination address of the packet into 10.10.10.2. The packet then gets a CA coding and it is passed on for embedding into the multiplexed transmission.

Optionally, a set utilising the CA function receives the transmission and performs de-multiplexing. It accepts packets carrying the same address as its TV set address, in this case 10.10.10.2. It carries out decoding of the packet, descrambles it and sends it through the bridge 46 into a local area network that can be the receiver's home network. The above functions can be carried out in the set-top box of a digital TV set.

The encapsulation of the IP address, either the original, or the translated address (10.10.10.2 in the example provided), in the CA packet provides an added advantage that the packets may be further routed in a network at the receiver site, as discussed above, while consuming only a single CA code. The transfer of IP packets as described above, from the IP domain to the digital television domain, and back to the IP domain, is commonly known as tunnelling, or IP forwarding.

It is also possible to transmit individually targeted packets via the IP network to digital receiver sets and devices possibly connected to them. A prerequisite for relaying IP packets is that the transmitter of the packets can identify the end receiver by a certain unique IP address. However, there are certain problems connected with issuing a unique IP address to each receiver. It is difficult—if not impossible—to allocate a sufficiently large address space from the present Internet address space for DVB data distribution use (millions of addresses). In addition, even if a unique address is allocated to each receiver set, the problem of configuring the set still remains. Who would carry it out, and what to do when the set has to be replaced? Who is in response of the co-ordination of IP numbers, how to fit the unique number in with existing local area networks to which the receiver set may possibly be connected?

As one answer to these questions, we can think of a solution where a network separated from the general IP address space is arranged for DVB. This network can be shared between TV companies, multiplexed transmission administrators, Internet operators and external service providers through a border router. In this case, the data network of DVB resembles the companies' internal networks and has the technical structure of a Virtual Private Network (VPN). The services produced for this VPN must originate from within the network. This aside, each service provider can use his chosen methods for producing the services and required data transmissions. However, the required technology exists and is readily available.

VPN will solve the problem of the IP address space but not that of coordinating and configuring the IP numbers of receiver sets. As a solution to this, a method can be considered that utilises the set identifying procedure in connection with the smart card.

When the IP packets intended for receiver sets arrive at the remote bridge where they will be coded into the format required by DVB transmissions, a code will be sought, based on the packet address (i.e. actually based on the receiver), which will only effect the authorisation of the set with the receiver's smart card inserted. At this stage, then, the transformation is made from the IP address into the Conditional Access (CA) authorisation code corresponding to the receiver's smart card.

It is important to note that the above embodiment constitutes more than just Network Address Translation (NAT). The CA code search 42 provides a translation of the IP based address to a CA based address. When combined in such remote bridging, the IP address is transformed (mainly) into a standard address that in principle may be the same for all receiver sets. This means that all receiver sets can be identical when they leave the factory—they can all be configured to have the same IP address ready. To avoid any conflicts, it is advantageous to reserve this standard address from the international IP address space.

If the receiver set is connected to an existing network, the IP address can in remote bridging be transformed into a receiver defined address instead of the standard one. This IP transformation may require manual configuring of the remote bridge, so it could be a paid service. We can assume that a user who wants to connect his receiver set to his own local area network, is also capable of changing his set's fixed IP address into one he has himself defined.

In any case, since the identification of the set is carried out by the CA code, the IP address can be allowed through as it is, after the authorisation has been done.

Since it pays to reserve the standard receiver set IP address from the general IP address space, and since the same address can be shared by almost all users, and since the smallest address space which can be reserved at a time is a class C address space covering 254 addresses, why not reserve an entire class C address space for the receivers? In this case, the receiver set in each home could relay information to a maximum of 253 additional devices connected to a network—for instance via a wireless one. The use of a class C address space would in practice mean that, at the remote bridge, the authorisation code could be sought based on the three highest bytes of the IP address (using a class C mask 255.255.255.0), and the lowest byte would be allowed straight through into the IP address relayed to the receiver set.

By joining the IP address with the authorisation code, both someone living in a remote cottage and the one having IT equipment of a company can be equally served.

It is possible to implement the invention in other ways than those described above while adhering to the methods defined in the patent claims. The application system can be other than a digital television system. Any system without a wireless or cable based return connection is suitable for this application. The given examples have described the return connection to be a modem connection through PSTN or ISDN networks. This is not obligatory; the return connection can be arranged in other ways. One possible method is to integrate a cellular phone in the receiver set. In this case, the telephone will contact the order server at the Internet service provider. Another possibility is to use a Short Message Service (SMS); in this case, the SMS is relayed to the service provider. In such cases, the receiver set could be a device totally independent of the electrical mains and telephone trunk network, such as a battery powered TV set.

While there have been described what are at present considered to be the preferred embodiments of this invention, it will be obvious to those skilled in the art that various other embodiments, changes, and modifications may be made therein without departing from the spirit or scope of this invention and that it is, therefore, aimed to cover all such changes and modifications as fall within the true spirit and scope of the invention, for which letters patent is applied.

We claim:

1. A method for addressing Internet Protocol (IP) packets having IP format address information, in a Conditional Access (CA) capable television network, the method comprising the steps of:
selecting a CA code from a database, using said IP format address or a portion thereof as search criteria; and,
encoding at least a portion of the data of said packet using said CA code, to produce a CA encoded data.

2. The method of claim 1 further comprising the step of transforming said CA encoded data to a format suitable for digital television transmission.

3. The method of claim 1 further comprising the step of transmitting said CA encoded data via a television distribution network.

4. The method of claim 1 further comprising the step of translating said IP address or a portion thereof, into a private address.

5. The method of claim 4 further comprising the step of embedding at least a portion of said private address in said CA encoded data.

6. The method of claim 5, wherein said at least portion of private address is embedded into said CA encoded data in an encoded format.

7. The method of claim 1 wherein said portion of IP address is the network prefix of said IP address.

8. The method of claim 1 wherein further comprising the step of embedding at least a portion of said IP address into said CA encoded data.

9. The method of claim 8, wherein said at least portion of IP address is encoded in said CA encoded data.

10. the method of claim 1 wherein said IP packets represent a multicast stream.

11. A method of integrating of a television based network with an Internet Protocol (IP) network, the method comprising the steps of:
receiving packets from an IP network, said packets having IP address information embedded therein;
selecting a conditional access (CA) code from a database, using said IP format address or a portion thereof as search criteria;
encoding at least a portion of the data of said packet using said CA code, to produce a CA encoded data; and
transmitting the CA encoded data via a television distribution network, for reception by a set-top box adapted to decode said CA encoded data.

12. The method of claim 11 further comprising the step of performing domain address translation on said IP address information, to form a private address.

13. The method of claim 12 further comprising the step of encoding at least a portion of said private address in said CA encoded data.

14. The method of 13, wherein said private address is encoded within the CA encoded data.

15. The method of claim 11 further comprising the step of embedding at least a portion of said IP address into said CA encoded data.

16. The method of claim 15, wherein said at least portion of IP address is encoded within the CA data

17. The method of claim 11 wherein at least a portion of said IP packets represent a multicast stream.

18. An arrangement for adapting packets received from a service in a computer network to further broadcasting in a broadcast network system,
characterized in that the arrangement comprises:
a scrambler key database storing a plurality of scrambler keys, each linked to at least one network prefix,
means for scrambling at least the payload of each packet with a scrambler key fetched from the scrambler key database on the basis of the domain address of the packet,
wherein the domain address of the packet received from the computer network determines the scrambling key applied to the payload of the packet.

19. The arrangement as in claim 18, characterized in that scrambling is a step of a conditional access system, wherein conditional access subsystems in the receivers are able to descramble packets only when authorized to do so.

20. The arrangement as in claim 18, characterized in that the arrangement further comprises:
an address database storing a plurality of intra-system addresses, each linked to at least one network prefix,
means for replacing the network prefix of each packet with the intra-system address fetched from the secondary address database on the basis of the domain address of the packet.

21. The arrangement as in claim 18, characterized in that an intra-system address is common to a group of receivers.

22. The arrangement as in claim 18, characterized in that a local part of the address of the packet received from the computer network remains, wherein a receiver is able to route the packet received from the broadcast network further towards equipment provided with said local address.
